(19) United States
(12) Patent Application Publication
(10) Pub. No.: US 2026/0128357 A1
(43) Pub. Date: May 7, 2026

(54) SOLID-STATE BATTERY SYSTEM

(71) Applicant: ContiTech Vibration Control GmbH, Hannover (DE)

(72) Inventors: Lukas Kuehne, Seelze (DE); Max Konstantin Werhahn, Hannover (DE); Peter Michael Marienfeld, Marklohe (DE)

(73) Assignee: ContiTech Vibration Control GmbH, Hannover (DE)

(21) Appl. No.: 19/116,684

(22) PCT Filed: Aug. 28, 2023
(86) PCT No.: PCT/DE2023/200174

§ 371 Date: Mar. 28, 2025

(30) Foreign Application Priority Data
Sep. 28, 2022 (DE) 10 2022 210 267.3

(51) Int. Cl. H01M 10/04; H01M 50/102; H01M 50/325; H01M 50/618; H01M 50/627; H01M 50/682

(52) U.S. Cl. CPC H01M 10/0468; H01M 50/102; H01M 50/325; H01M 50/618; H01M 50/627; H01M 50/682; H01M 2200/20; H01M 2300/0065

(57) ABSTRACT

The present invention relates to a solid-state accumulator system having at least one solid-state accumulator system with a preferential dimensional-change direction and having at least one solid-state accumulator holder, which is configured to counteract the dimensional change of the solid-state accumulator in the dimensional-change direction by means of at least one variable fluid volume.

### CROSS-REFERENCE TO RELATED APPLICATIONS

This application is a National Stage Application under 35 U.S.C. § 371 of International Patent Application No. PCT/DE 2023/200174 filed on Aug. 28, 2023, and claims priority from German Patent Application No. 10 2022 210 267.3 filed on Sep. 28, 2022, the disclosures of which are herein incorporated by reference in their entireties.

### BRIEF SUMMARY

The present invention relates to a solid-state accumulator system and to a solid-state accumulator holder for use in such a solid-state accumulator system.

It is known to store electrical energy in order to allow the electrical energy to be used at a later time and/or in a mobile manner. Mobile applications can be, for example, electronic entertainment and communication devices such as, for example, mobile telephones as well as vehicles which can be driven partially or completely electrically.

In each case, rechargeable electrical energy stores can be used for this purpose, which may also be referred to as accumulators. Accumulators are also referred to as secondary batteries and are abbreviated colloquially to “Akkus” in German. An accumulator is a rechargeable galvanic element, which comprises two electrodes and an electrolyte, which is able to store the electrical energy electrochemically. The electrolyte in question serves to conduct ions between an anode and a cathode.

Depending on the application, accumulators can be produced in different sizes and shapes. For example, the accumulators of mobile telephones are usually flat and rectangular, in order to be as space-saving as possible. If the required installation space is not as important, then accumulators are often cylindrical. Cylindrical accumulators and rectangular accumulators are used for many domestic electrical devices. Cylindrical accumulators in particular are mostly used in multiples and are connected in series and/or arranged one behind the other so as to contact one another directly, for example in remote controls for electronic devices and the like.

In battery electric vehicles (BEV) too, which may also be referred to as electric cars, a large number of accumulators, in particular cylindrical accumulators, are usually used in combination with one another. The accumulators are often arranged spatially parallel to one another in the bottom of the chassis of the vehicle. The individual accumulators can be interconnected according to the application or according to the manufacturer.

The accumulators differ from one another substantially in terms of the technology of the storage of the electrical energy, which is dependent substantially on the electrolyte used. Thus, lithium-ion accumulators, which are based on lithium compounds in all three phases of the electrochemical cell, are widely used nowadays. Lithium-ion accumulators have a comparatively high specific energy, that is to say a comparatively high energy per unit mass, and are usually used in mobile telephones but also in battery electric vehicles. In battery electric vehicles, however, lead-or nickel-based accumulators are also used. It is common to these accumulators that a liquid electrolyte is used in each case.

A common disadvantage of accumulators with liquid electrolytes is that the accumulators have to be cooled in order to prolong the working life of the electrodes. This represents a not inconsiderable additional outlay. In particular, the required cooling and other devices can account for more than half of the volume of, for example, a lithium-ion accumulator. In order to prolong the working life of the accumulators, full charging and discharging thereof should also be avoided.

A further disadvantage of accumulators with liquid electrolytes is that most liquid electrolytes are combustible, which can make additional safety devices necessary. Furthermore, the liquid electrolyte can escape in the event of damage, which can likewise lead to additional safety measures. A further safety risk can occur in the case of accumulators with liquid electrolytes as a result of very low or very high ambient temperatures, since the liquid electrolytes can then freeze or boil.

Accumulators with an electrolyte of solid material are further known, which may also be referred to as solid-state accumulators. Owing to the solid materials of the electrolytes, the electrolytes cannot escape in the event of damage, which can increase the safety of the use of solid-state accumulators, or corresponding additional safety measures can be dispensed with. Also, the solid materials of the electrolytes are not normally flammable. Furthermore, solid-state accumulators usually have a longer working life than accumulators with liquid electrolytes and are easier to store. Solid-state accumulators can also be miniaturized more easily and can be manufactured in particular in the form of a thin layer. Furthermore, solid-state accumulators do not usually exhibit any safety problems or any abrupt changes in their power in the event of temperature fluctuations.

A disadvantage of solid-state accumulators is, however, that they have hitherto exhibited a lower power density and a higher energy density than accumulators with liquid electrolytes. This can have a correspondingly detrimental effect on the applications, since it can correspondingly limit the accelerating ability of battery electric vehicles.

It is also a disadvantage that, in solid-state accumulators, or in the anode thereof, a significant dimensional change of, for example, 20% can occur on charging and on discharging. The dimensional change can correspondingly occur in particular in a longitudinal direction of extent of the solid-state accumulator, that is to say, for example in the case of cylindrical solid-state accumulators, in the direction of the longitudinal axis, in which the electrodes are also located opposite one another. The dimensional change, or this change in length, between the charged and the discharged, or uncharged, state of the solid-state accumulator may also be referred to as “breathing”.

A further disadvantage is that solid-state accumulators must be compressed with a comparatively high pressure of over about 10 bar, in particular between about 10 bar and about 30 bar, in order to achieve an acceptable, in particular a good, degree of efficiency, since the pressure that is exerted can lead to better contact between the solid particles and can thus increase the electrical conductivity. In the case of solid-state accumulators with a longitudinal direction of extent, this pressure is usually exerted in the longitudinal direction of extent, that is to say, for example in the case of cylindrical solid-state accumulators, in the direction of the longitudinal axis.

In any case, particular requirements are thus made of solid-state accumulators, or of the housing and the like which surround the solid-state accumulators.

An object of the present invention is to improve the possible uses of solid-state accumulators. This is to be effected in as simple, robust, versatile, inexpensive and/or space-saving a manner as possible.

The object is achieved according to the invention by a solid-state accumulator system and by a solid-state accumulator holder having the features of the independent claims. Advantageous refinements are described in the dependent claims.

Accordingly, the present invention relates to a solid-state accumulator system having at least one solid-state accumulator with a preferential dimensional-change direction and having at least one solid-state accumulator holder, which is configured to counteract the dimensional change of the solid-state accumulator in the dimensional-change direction by means of at least one variable fluid volume.

The present invention is based on the finding that, as described at the beginning, solid-state accumulators, or the anode thereof, tend in principle to become smaller when the stored electric charge is discharged and to increase in size again on charging, which may also be referred to as “breathing” of the solid-state accumulator. This takes place substantially in one spatial direction, which may thus be referred to as the preferential dimensional-change direction, since the greatest dimensional change due to the “breathing” of the solid-state accumulator, or of the accumulator cell or accumulator cells thereof, takes place in this spatial direction. This dimensional change has an effect in particular in the direction of the longitudinal extent of the solid-state accumulator, so that the direction of the longitudinal extent may also be referred to as the preferential dimensional-change direction. This is usually also the direction in which the two electrodes of the solid-state accumulator are spaced apart from one another, or are separated by a separating layer.

In order to be able to hold or fix a solid-state accumulator in the preferential dimensional-change direction despite the regular significant dimensional change, which can easily amount to 20% of the longitudinal extent of the solid-state accumulator, there is proposed according to the invention a solid-state accumulator holder, which is able to counteract this dimensional change by means of at least one variable fluid volume. To this end, when the solid-state accumulator is at the minimum size in the preferential dimensional-change direction, that is to say is in the fully or largely discharged state, the variable fluid volume can be at least almost or completely without force, or can rest or be held loosely against the solid-state accumulator, and on charging, by means of the pressure of the fluid of the variable fluid volume, can counteract the resulting increase in size of the solid-state accumulator in the preferential dimensional-change direction, so that the solid-state accumulator can on the one hand be held in the direction of the preferential dimensional change even during “breathing” but is nevertheless able in principle to expand in the preferential dimensional-change direction. The solid-state accumulator can thus be held securely despite “breathing”.

The dimensional change, or breathing, of the accumulator cell as it increases in size can, however, also be counteracted in such a manner that, in the fully or largely discharged state, when the accumulator cells are expanded the least in the preferential dimensional-change direction, a predetermined force is exerted on the accumulator cell by the solid-state accumulator holder according to the invention, said force also being maintained, as constantly as possible, when the accumulator cell then expands on charging. By means of such preloading, that is to say by means of a force that acts on the accumulator cells even when they are not expanded, the uncharged accumulator cell can also be subjected to force, or pressure, and compressed, which can support, or optionally make possible in the first place, the functioning of solid-state accumulator cells.

In any case, the counteraction according to the invention of the dimensional change, or breathing, of the accumulator cell as it increases in size does not prevent the dimensional change thereof at all but merely presents a resistance to the dimensional change, or breathing, so that the dimensional change, or breathing, can take place against a predetermined force. In particular, it takes place against a predetermined force that is as constant as possible over the entire distance of the dimensional change. The counteraction of the increasing dimensional change of the accumulator cell as it breathes can also be understood as an equalization of the force that is exerted by the increasing dimensional change as the accumulator cell breathes, in order to establish an equilibrium between the forces which can persist even in the case of different sizes of the accumulator cell.

In any case, as the accumulator cell expands, the counteracting force can be reduced or kept constant so as not to press too heavily against the accumulator cell. This can be effected, for example, by discharging the fluid.

In any case, this force also acts in the opposite direction and compresses the accumulator cell again when it is discharged and thus contracts in the preferential dimensional-change direction.

In any case, it can thus preferably be ensured that a defined preload is sufficiently high, but not too high, in any charge state, that is to say at any size, of the accumulator. In particular, the preload can remain within a defined pressure window.

In order to implement this, the fluid of the variable fluid volume of the solid-state accumulator holder exerts a force on the solid-state accumulator against the preferential dimensional-change direction thereof, in particular in order to exert as constant a force as possible on the accumulator cell regardless of the size or charge state of the accumulator cell. In other words, a dimensional change of the solid-state accumulator, or of the anode thereof, in the preferential dimensional-change direction on charging acts on the solid-state accumulator holder, or on the at least one variable fluid volume thereof, in such a manner that the solid-state accumulator expanding in the preferential dimensional-change direction compresses the fluid of the variable fluid volume in a compressible manner or, in the case of an incompressible fluid, pushes it against a force out of the variable fluid volume, so that the compressibility of the fluid, or the counterforce of the incompressible fluid, counteracts this expansion, in particular with a force that is as constant as possible.

In principle, the variable fluid volume is thus to be understood, functionally, as meaning that, according to the invention, by means of a fluid, which can be a (compressible) gas or a (incompressible) liquid, the volume occupied by the fluid relative to the solid-state accumulator that is changeable in terms of size in the preferential dimensional-change direction, or the at least one accumulator cell thereof, is variable in such a manner that a force that is as constant as possible can be exerted on the accumulator cell in the opposite direction to the increasing dimensional change of the solid-state accumulator, or of the accumulator cell thereof. This applies equally for the decreasing dimensional change of the solid-state accumulator, or of the accumulator cell thereof, as it contracts.

To this end, the fluid in the form of a compressible gas can be compressed by the expanding solid-state accumulator, or the accumulator cell thereof, and thus oppose a force to the dimensional change of the solid-state accumulator, or of the accumulator cell thereof. Correspondingly, a force can also be exerted by the gas on the contracting solid-state accumulator, or the accumulator cell thereof. In any case, a preload, or a preload force, can be exerted by the gas on the minimal solid-state accumulator, or the accumulator cell thereof, by introducing the gas with a predetermined pressure.

Alternatively, the fluid in the form of an incompressible liquid can be pushed by the expanding solid-state accumulator, or the accumulator cell thereof, out of the space between the solid-state accumulator, or the accumulator cell thereof, and the solid-state accumulator holder, for which purpose an additional equalizing volume can be used, as will be explained further hereinbelow. Correspondingly, a force can also be exerted by the liquid on the contracting solid-state accumulator, or the accumulator cell thereof. In any case, a preload, or a preload force, can be exerted by the liquid on the minimal solid-state accumulator, or the accumulator cell thereof, by correspondingly designing the equalizing volume, or the entire fluid space including lines.

In any case, a casing of the variable fluid volume can be formed by a housing of the solid-state accumulator holder, in which the solid-state accumulator, or the accumulator cell thereof, is movable as a piston, or also by a supplementary, in particular elastic, element, which can be compressed from outside by the solid-state accumulator, or the accumulator cell thereof, and can expand again automatically. The variable fluid volume can thus also refer structurally to the casing, or the element, that at least substantially encloses the functionally variable fluid volume, and may also be referred to as a fluid cushion, a hydraulic cushion or an air cushion.

In any case, it can facilitate the use of a variable fluid volume to achieve a compact arrangement or a compact construction of the solid-state accumulator holder. To this end, the variable fluid volume acting in the preferential dimensional-change direction of the solid-state accumulator can be arranged on one side or on both sides relative to the solid-state accumulator.

In particular, a variable fluid volume can have a degressive profile of the characteristic curve of the spring stiffness owing to the compressibility of the gas or the counterforce of the equalizing volume of the fluid as the solid-state accumulator, or the accumulator cell thereof, expands in the preferential dimensional-change direction, so that as constant a counterforce as possible, or as constant a pressure as possible, can be exerted by the variable fluid volume on the solid-state accumulator, or on the accumulator cell thereof, over the full span of the dimensional change of the solid-state accumulator, or of the accumulator cell thereof.

In any case, according to the invention, the solid-state accumulator, or the accumulator cell thereof, can in this manner be held securely by the solid-state accumulator holder both in the discharged and charged state and during the discharging and charging process. This can be effected despite the significant dimensional change in the preferential dimensional-change direction during the discharging and charging process. By means of the solid-state accumulator holder, the solid-state accumulator, or the accumulator cell thereof, can be connected to and thus securely held on an apparatus or a device that can be supplied with power or operated by means of the solid-state accumulator.

Preferably, the variable fluid volume, or the casing thereof, comprises or consists of an elastomeric material such as, for example, an ethylene-propylene-diene rubber, a natural rubber or silicone. These can constitute particularly simple, inexpensive and/or durable possibilities for implementation.

According to one aspect of the invention, the variable fluid volume is formed by a gas, preferably by air, or the variable fluid volume is filled with a gas. This can constitute one possibility for implementation, as described above.

According to a further aspect of the invention, the solid-state accumulator holder comprises at least one compressor, which is configured and adapted to generate a predetermined pressure of the gas. The fluid volume, or the quantity of gas within the fluid volume, can thus be increased in order to exert a higher pressure on the solid-state accumulator, or on the accumulator cell thereof, and/or in order to maintain a constant pressure on the solid-state accumulator, or on the accumulator cell thereof. This can constitute one possibility for implementation, as described above.

According to a further aspect of the invention, the solid-state accumulator holder comprises at least one check valve, which is configured and adapted to open at a predetermined pressure of the variable fluid volume. The fluid volume, or the pressure or the quantity of gas within the fluid volume, can thus be reduced in order to exert a low pressure on the solid-state accumulator, or on the accumulator cell thereof, or to counteract the dimensional change thereof. This can constitute one possibility for implementation, as described above.

According to a further aspect of the invention, the variable fluid volume is formed by a liquid, preferably by a hydraulic liquid, wherein the solid-state accumulator holder comprises at least one variable equalizing volume, which is connected in a liquid-conducting manner to the variable fluid volume and is configured to exert a force on the liquid. This can constitute a further possibility for implementation, as described above.

According to a further aspect of the invention, the variable equalizing volume is configured as an elastic equalizing volume with an elastic outer shell, which holds the liquid in an inner volume. This can constitute one possibility for implementation of an equalizing volume. In particular, this can be effected particularly easily, since active or movable elements such as drives and the like can be omitted.

According to a further aspect of the invention, the elastic outer shell comprises, preferably consists of, an elastomeric material, which is preferably fiber-reinforced and/or provided with tension cords, or a textile material provided with a sealing membrane. These can be concrete possibilities for implementation in order to utilize the respective properties and advantages. This can in particular improve the transmission of tensile forces by the elastic outer shell and thus increase in particular the durability of the elastic outer shell.

According to a further aspect of the invention, the variable equalizing volume is configured as a rigid equalizing volume with an equalizing chamber, the volume of which is variable by means of a movable spring-loaded or pressure-loaded piston or by means of an elastic membrane. These can be alternative possibilities for implementation.

According to a further aspect of the invention, the variable fluid volume is configured to exert a preload on the solid-state accumulator. This can be effected by a corresponding design of the variable fluid volume, in that, even at the minimal size of the fully discharged solid-state accumulator, a counterforce or a pressure of the variable fluid volume can be exerted on the solid-state accumulator, or on the accumulator cell thereof, in the preferential dimensional-change direction, said force compressing and thus preloading the solid-state accumulator in the direction of the preferential dimensional change. In other words, as uniform a preload as possible can be ensured on the solid-state accumulator, or on the accumulator cell thereof, regardless of the charge state of the solid-state accumulator, or of the accumulator cell thereof, so that the conductivity and thus the maximum power of the accumulator cell is not influenced or is influenced as little as possible by the “breathing”.

This counterforce or pressure of the variable fluid volume of the tension spring can be regarded as preloading of the variable fluid volume and can preferably be at least about 10 bar, particularly preferably between about 10 bar and about 30 bar. In this manner, the solid-state accumulator, or the anode, cathode and electrolyte thereof, can be compressed in order to increase the degree of efficiency, since the pressure that is exerted can lead to better contact between the solid particles and can thus increase the electrical conductivity.

According to a further aspect of the invention, the solid-state accumulator holder comprises at least one fluid inlet, which is configured and adapted to allow the quantity of fluid of the variable fluid volume to be introduced. This can make it possible, or make it easier, for the quantity of fluid to be introduced or kept constant. Losses of fluid, which can occur during operation as a result of leaks etc., can thus be compensated for.

According to a further aspect of the invention, the solid-state accumulator holder comprises at least one pressure sensor, which is configured and adapted to detect a pressure of the fluid within the variable fluid volume. On the basis of the pressure values acquired by means of the sensor, it can be recognized, for example, whether or when the fluid is to be introduced, for example in order to keep the quantity of fluid within the variable fluid volume constant or in order to increase the pressure within the variable fluid volume, for example by means of a compressor.

According to a further aspect of the invention, the variable fluid volume comprises, preferably consists of, an elastomeric material, which is preferably fiber-reinforced and/or provided with tension cords, or a textile material provided with a sealing membrane. These can be concrete possibilities for implementation in order to utilize the respective properties and advantages. This can in particular improve the transmission of tensile forces by the variable fluid volume and thus in particular increase the durability of the variable fluid volume.

According to a further aspect of the invention, the solid-state accumulator comprises a plurality of accumulator cells, which are arranged in the preferential dimensional-change direction and/or perpendicular to the preferential dimensional-change direction, wherein the solid-state accumulator holder is configured to counteract the dimensional change of all the accumulator cells in the dimensional-change direction by means of at least the variable fluid volume. This can increase the freedom of design for use of the present invention. In particular, the outlay for implementation of the present invention can be kept correspondingly low.

According to a further aspect of the invention, the solid-state accumulator holder comprises a plurality of variable fluid volumes, which are configured and arranged to counteract the dimensional change of an accumulator cell or of a plurality of accumulator cells of the solid-state accumulator in the dimensional-change direction on one side or on both sides. This can increase the freedom of design for use of the present invention. In particular, the outlay for implementation of the present invention can be kept correspondingly low.

According to a further aspect of the invention, the solid-state accumulator holder comprises at least one variable supplementary volume, which is arranged parallel to the variable fluid volume, wherein the variable supplementary volume is connected by means of a first check valve to an ambient fluid, preferably to the ambient air, in order to receive ambient fluid when the pressure is falling, and wherein the variable supplementary volume is connected by means of a second check valve to the variable fluid volume in order to discharge fluid to the variable fluid volume when the pressure is rising, so that a constant pressure can be maintained in the variable supplementary volume. A pressure equalization of the variable supplementary volume can thus be carried out without active measures, comparably to the inflation of an air pump.

Preferably, a spring-loaded check valve can be provided on the side of the variable fluid volume, in order to avoid excess pressure there.

The present invention relates also to a solid-state accumulator holder for use in a solid-state accumulator system as described above. A solid-state accumulator holder can thus be provided in order to allow a solid-state accumulator system according to the invention as described above to be implemented.

In other words, the present invention is based on the object of suitably preloading a solid-state battery or a plurality of solid-state batteries with as small a volume as possible and/or with as low a weight as possible and allowing the cells to breathe or expand during charging and discharging. The maximum permissible pressure on the cell should not be exceeded. The preloading element should in particular have a degressive characteristic curve, in order to keep the change in the preload during charging and discharging as small as possible.

The solution to the stated problem involves the use of a hydraulic cushion or of an air cushion at one or both end plates of the cell.

The cushion filled with a medium can be connected to an equalizing volume. As the cell expands, the cushion can be compressed and, if the force is sufficiently high, the volume can be pushed into the equalizing volume. If the expansion of the cell falls, then the pressure on the end plates reduces and the volume from the equalizing chamber is pushed back into the cushion.

In order to maintain the pressure, a compressor, for example, or a preloaded cylinder (e.g. preloaded with a plate spring) can be used. Alternatively, the equalizing volume itself can be an elastic chamber, for example an elastomer bladder (similar to a balloon), so that, as a result of the increasing expansion as the pressure increases, the wall thickness falls and a degressive behavior is established. In the case of a falling load, the volume is again pumped out of the elastic chamber into the cushion.

By using an air chamber or a hydraulic chamber, a degressive characteristic curve can be generated. In an extreme case, the preload on the cell remains constant.

Because the pressure within the air cushion is constant, the preload force is introduced uniformly into the end plate. A further advantage is that the cushion can be compressed to a minimal height of the cushion wall in the case of elongation of the cell and can thus offer a significant advantage in terms of installation space.

The equalizing volume can be integrated in the battery in a flexible manner at any desired location. When a compressor is used, the installation space is reduced only by the volume thereof.

An air cushion offers the advantage that air is compressible and thus the equalizing volume, the degressivity of the characteristic curve profile and the applied preload on expansion and contraction can be adapted to the optimal conditions. Optionally, the end plate can be very thin (e.g. a thin metal/plastics plate) or can be omitted entirely (the air cushion introduces the preload directly and uniformly) and thus installation space can additionally be obtained and weight can be reduced.

For example, in one embodiment, the cushion can be in the form of an air chamber, which is delimited by an elastomer. This cushion can be supplied with a constant pressure via a compressor and can have a pressure relief valve, so that the pressure that is applied to the cell corresponds exactly to the required preload force of the cell. The air cushion and the cell (or the cells) can be integrated in a housing or braced by a belt.

In a further variant, a plurality of air cushions can be connected to the same compressor (for example air-conditioning compressor) and the same pressure relief valve.

In a further variant, the compressor and the pressure relief valve can be replaced by an elastic equalizing volume.

In a further variant, a central elastic equalizing volume can be used for two or more cells, the individual air cushions being connected to the equalizing volume.

In a further variant, the compressor and the pressure relief valve can be replaced by a preloaded piston and a rigid equalizing volume. The piston can be so preloaded that it generates a degressive characteristic curve.

In a further variant, the compressor and the pressure relief valve can be replaced by a pressure equalizing chamber having an integrated elastomeric pressure regulating membrane.

Optionally, a compressor can be used in addition to the equalizing volume, in order to compensate for air losses over the lifetime and temperature influences.

Optionally, an air refill device can be provided, at which the air pressure is checked at regular intervals and optionally corrected (e.g. during an inspection or by the TÜV (Technischer Überwachungsverein [Technical Inspection Association])).

Optionally, an air refill device and a pressure sensor can be provided, at which the air pressure is determined and optionally reported to the driver via a need to refill (similarly to a tire pressure sensor).

The elastomer shell of the air cushion can be fiber-reinforced or designed with tension cords.

The air cushion can also be produced without an elastomer and, instead of the elastomer, of textile with a sealing membrane, for example.

A further variant can consist in preloading two or more cells with one cushion and thus reducing the outlay in terms of assembly.

In one embodiment, the cells can be inserted into the battery housing, followed by the application of a large air cushion and of the housing cover. After the cover has been fitted, the preload can be applied to the individual cells by filling the cushion. The above-mentioned possibilities are available for the design of the equalizing volume or the like.

A further possibility for the equalizing volume is a pressure vessel which comprises two or more chambers separated from one another by one or more membranes. A force equilibrium prevails between the two sides of each membrane. A fluid cushion or a plurality of fluid cushions is/are connected on one side, and the other side is filled, for example, with air at a defined pressure. As the air cushions are compressed, fluid is conducted into the equalizing chamber and the force on the membrane is thus increased. The air on the other side is compressed, so that a counterforce is generated. A new equilibrium is established, so that the system returns to the original state when the pressure is released.

A further possibility is to use the cell expansion to generate the necessary air volume. This can be effected either directly by a certain overexpansion of an elastic chamber or by an energy harvesting principle, in which the energy that is recovered is converted into fluid pressure at a later time. A possibility of using the cell expansion for energy harvesting or the integration of a pressure regulation is an additional air cushion, which is compressed as the cell expands and is connected by a pressure relief valve (e.g. 3 MPa) to at least one air cushion or to the equalizing volume. In addition, the additional air cushion is equipped with a one-way valve with respect to the atmosphere, so that, on decompression of the cell, air at atmospheric pressure is able to flow in. The advantage is that the system can function without a compressor and additional energy and is able to compensate automatically for small leaks and settlement of the elastic chamber.

It is conceivable to apply this solution to fields of application of the preloading of fixed solid-state batteries or fuel cells.

### BRIEF DESCRIPTION OF THE DRAWINGS

Several exemplary embodiments and further advantages of the invention will be explained hereinbelow in connection with the following figures, in which:

FIGS. 1 to 10 each show a schematic representation of a solid-state accumulator system according to the invention having a solid-state accumulator holder according to the invention according to a first to tenth exemplary embodiment.

FIG. 1 shows a schematic representation of a solid-state accumulator system 1, 2.

FIG. 2 shows a schematic representation of a solid-state accumulator system 1, 2.

FIG. 3 shows a schematic representation of a solid-state accumulator system 1, 2.

FIG. 4 shows a schematic representation of a solid-state accumulator system 1, 2.

FIG. 5 shows a schematic representation of a solid-state accumulator system 1, 2.

FIG. 6 shows a schematic representation of a solid-state accumulator system 1, 2.

FIG. 7 shows a schematic representation of a solid-state accumulator system 1, 2.

FIG. 8 shows a schematic representation of a solid-state accumulator system 1, 2.

FIG. 9 shows a schematic representation of a solid-state accumulator system 1, 2.

FIG. 10 shows a schematic representation of a solid-state accumulator system 1, 2.

The above-mentioned figures are described in Cartesian coordinates with a longitudinal direction (not shown), a transverse direction Y oriented perpendicular to the longitudinal direction, and a vertical direction Z oriented perpendicular to both the longitudinal direction and the transverse direction Y. The longitudinal direction may also be referred to as the depth, the transverse direction Y also as the width Y and the vertical direction Z also as the height Z. The longitudinal direction and the transverse direction Y together form the horizontal, which may also be referred to as the horizontal plane. The longitudinal direction, the transverse direction Y and the vertical direction Z may together also be referred to as spatial directions Y, Z or as Cartesian spatial directions Y, Z.

### DETAILED DESCRIPTION

A solid-state accumulator 1 that in each case comprises at least one accumulator cell 10 is always considered. The accumulator cell 10 is a rechargeable galvanic element, which comprises two electrodes (not shown), that is to say an anode and a cathode, and an electrolyte (not shown), which is able to store the electrical energy electrochemically and serves to conduct ions between the electrodes. The electrolyte is a solid-state material. The two electrodes lie opposite one another in the vertical direction Z and enclose the electrolyte between them.

In accumulator cells 10 with a solid electrolyte, it is known that a significant dimensional change of, for example, about 20% can occur on charging and discharging. This dimensional change, or change in length, may also be referred to as “breathing”. The dimensional change can occur substantially in a longitudinal direction of extent of the accumulator cell 10, which in the exemplary embodiments in question corresponds to the vertical direction Z, in which the electrodes also lie opposite one another. The preferential dimensional-change direction A thus corresponds to the longitudinal direction of extent of the accumulator cell 10 (otherwise shown schematically in order to improve clarity) and thus to the vertical direction Z. The preferred dimensional-change direction A may also be referred to as the expansion/compression direction A.

In accumulator cells 10 with a solid electrolyte, it is advantageous to compress the accumulator cells 10 with a comparatively high pressure of over about 10 bar, in particular between about 10 bar and about 30 bar, since the pressure that is exerted can lead to better contact between the solid particles of the electrolyte and can thus improve the electrical conductivity. The direction in which this pressure is exerted corresponds in the exemplary embodiments in question to the longitudinal direction of extent of the accumulator cell 10 and thus to the vertical direction Z, or the preferential dimensional-change direction A.

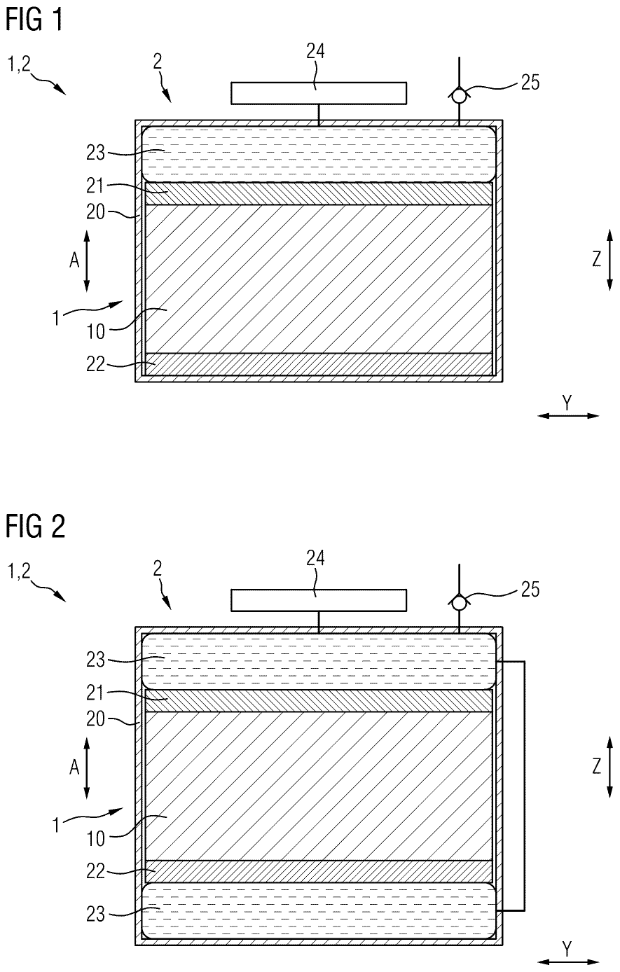

FIG. 1 shows a schematic representation of a solid-state accumulator system 1, 2 according to the invention having a solid-state accumulator holder 2 according to the invention according to a first exemplary embodiment. The accumulator cell 10 of the solid-state accumulator 1 is enclosed by a solid-state accumulator holder 2, which has a frame 20, which holds or encloses the solid-state accumulator 1 and further elements of the solid-state accumulator holder 2, wherein other elements of the solid-state accumulator holder 2 may also be arranged externally on the frame 20. The frame 20 may also be referred to or configured as a holder 20 or as a housing 20.

Within the frame 20 there is arranged a pair of holding elements 21, 22, which each lie flat against the solid-state accumulator 1 parallel to one of the electrodes. The holding elements 21, 22 may also be referred to as holding plates 21, 22 or as end plates 21, 22. The first holding element 21 may also be referred to as the upper holding element 21 and the second holding element 22 may also be referred to as the lower holding element 22.

In the first exemplary embodiment of FIG. 1, the second, lower holding element 22 lies flat against the inner side (not designated) of the base (not designated) of the housing 20, that is to say the second, lower holding element 22 is arranged in the vertical direction Z in direct contact between the housing 20 and the accumulator cell 10, or one electrode thereof.

The first, upper holding element 21 is arranged opposite in the vertical direction Z on the other electrode of the accumulator cell 10. There is arranged there, likewise flat and in parallel, a variable fluid volume 23 in the form of an elastic fluid cushion 23, which is filled with air and may therefore also be referred to as an air cushion 23. Alternatively, it would also be possible to use hydraulic liquid. A compressor 24 is further connected to the variable fluid volume 23, in order to increase the air pressure therein. There is also a check valve 25 or one-way valve 25 as a pressure relief valve 25, in order to open at a predetermined pressure and release pressure from the variable fluid volume 23.

According to the first exemplary embodiment of FIG. 1, a sufficiently high pressure can thus be generated by means of the compressor 24 within the variable fluid volume 23 in order to subject the accumulator cell 10 to a predetermined force in the vertical direction Z from above, or in its preferential dimensional-change direction A, and thus apply the predetermined force, or a corresponding predetermined pressure, to the accumulator cell 10. This can bring about a desired preload.

Furthermore, if the accumulator cell 10 expands or “breathes” in the vertical direction Z as its preferential dimensional-change direction A, the air pressure in the variable fluid volume 23 can be reduced by means of the check valve 25, which is correspondingly designed, in order to keep the pressure on the accumulator cell 10 constant and nevertheless allow the accumulator cell 10 to expand.

Conversely, as the accumulator cell 10 contracts, the force or pressure on the accumulator cell 10 can be kept constant by correspondingly increasing the air pressure within the variable fluid volume 23 by means of the compressor 24.

Thus, according to the invention, by means of a variable air-filled fluid volume 23, a dimensional change of the accumulator cell 10 can be made possible and at the same time a constant force or a constant pressure of, for example, about 10 bar can be exerted on the accumulator cell 10 in order to improve contact between the solid particles of the electrolyte and thus increase the electrical conductivity. By means of the variable quantity of air within the variable fluid volume 23, which can be increased by the compressor 24 and reduced by the check valve 25, a degressive profile of the characteristic curve of the spring stiffness of the variable fluid volume 23 can be achieved, so that as constant a pressure force as possible can be exerted on the accumulator cell 10 by the variable fluid volume 23 over the full span of the dimensional change. Correspondingly, the pressure force, or the pressure, for compressing the solid particles of the electrolyte can also be exerted comparatively constantly despite the significant dimensional change of the accumulator cell 10, or the anode thereof, as it “breathes”.

FIG. 2 shows a schematic representation of a solid-state accumulator system 1, 2 according to the invention having a solid-state accumulator holder 2 according to the invention according to a second exemplary embodiment. In this case, a pair of variable fluid volumes 23 is arranged on both sides of the accumulator cell 10 in the vertical direction Z, so that the above-described properties can be implemented on both sides. The two variable fluid volumes 23 are connected together in a fluid-conducting manner (not designated).

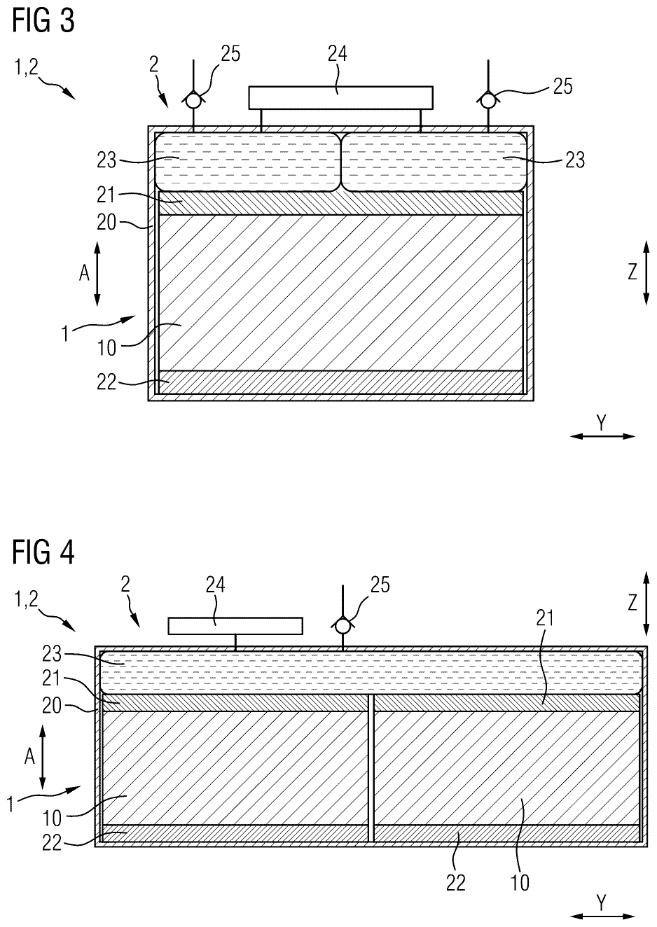

FIG. 3 shows a schematic representation of a solid-state accumulator system 1, 2 according to the invention having a solid-state accumulator holder 2 according to the invention according to a third exemplary embodiment. In this case, a pair of variable fluid volumes 23 is arranged side by side on the same side of the accumulator cell 10 and connected in each case to the compressor 24. Each variable fluid volume 23 has its own check valve 25 with the same threshold for opening. This can constitute an alternative possibility for implementation. It is also possible for more accumulator cells 10 to be operated in this manner.

FIG. 4 shows a schematic representation of a solid-state accumulator system 1, 2 according to the invention having a solid-state accumulator holder 2 according to the invention according to a fourth exemplary embodiment. In this case, two accumulator cells 10 are arranged side by side or parallel to one another, on which cells a variable fluid volume 23 can act as described with reference to the first exemplary embodiment of FIG. 1. This can constitute an alternative possibility for implementation. It is also possible for more than two accumulator cells 10 to be used and/or these can also be arranged in a different way, or as desired.

FIG. 5 shows a schematic representation of a solid-state accumulator system 1, 2 according to the invention having a solid-state accumulator holder 2 according to the invention according to a fifth exemplary embodiment. In this case, two arrangements of accumulator cells 10 and variable fluid volumes 23 as described with reference to the first exemplary embodiment of FIG. 1 are arranged parallel to one another, but they have a common compressor 24 and a common check valve 25. This can constitute an alternative possibility for implementation. It is also possible for more than two accumulator cells 10 to be used and/or these can also be arranged in a different way, or as desired.

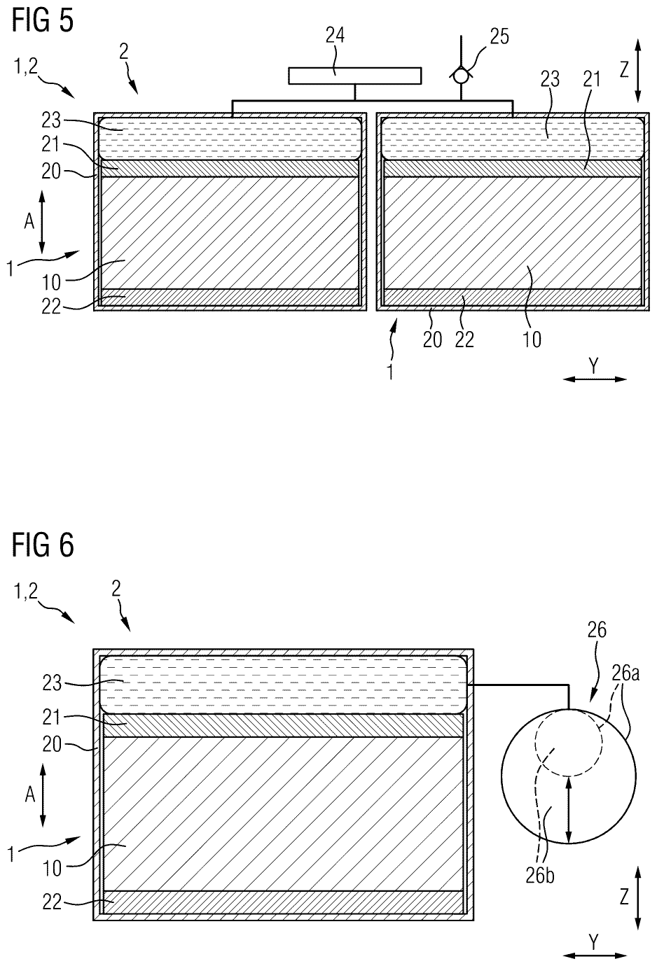

FIG. 6 shows a schematic representation of a solid-state accumulator system 1, 2 according to the invention having a solid-state accumulator holder 2 according to the invention according to a sixth embodiment. This exemplary embodiment corresponds to the first exemplary embodiment of FIG. 1, with the difference that in this case there is used an elastic equalizing volume 26, which comprises an elastic outer shell 26a in the form of an elastomer bladder 26a, which encloses an inner volume 26b in the form of an elastic chamber 26b. The inner volume 26b of the elastic equalizing volume 26 is connected in a fluid-conducting manner to the inner volume of the variable fluid volume 23.

The inner volume of the variable fluid volume 23 and the inner volume 26b of the elastic equalizing volume 26 are filled with a hydraulic liquid, so that a constant pressure prevails within the inner volume of the variable fluid volume 23 and the inner volume 26b of the elastic equalizing volume 26. If the variable fluid volume 23 is compressed by the expanding accumulator cell 10, then the hydraulic liquid that is thereby displaced from the variable fluid volume 23 is taken up by the elastic equalizing volume 26 in that the elastic outer shell 26a thereof in the form of the elastomer bladder 26b correspondingly expands. This elastic deformation of the elastomer bladder 26a of the elastic equalizing volume 26 also has the effect that the hydraulic liquid is pushed out of the elastomer bladder 26a again and back into the variable fluid volume 23 if the accumulator cell 10 becomes shorter again. The invention as described above can thus also be implemented by means of a hydraulic liquid as the fluid. A gas such as, for example, air could also be used as the fluid.

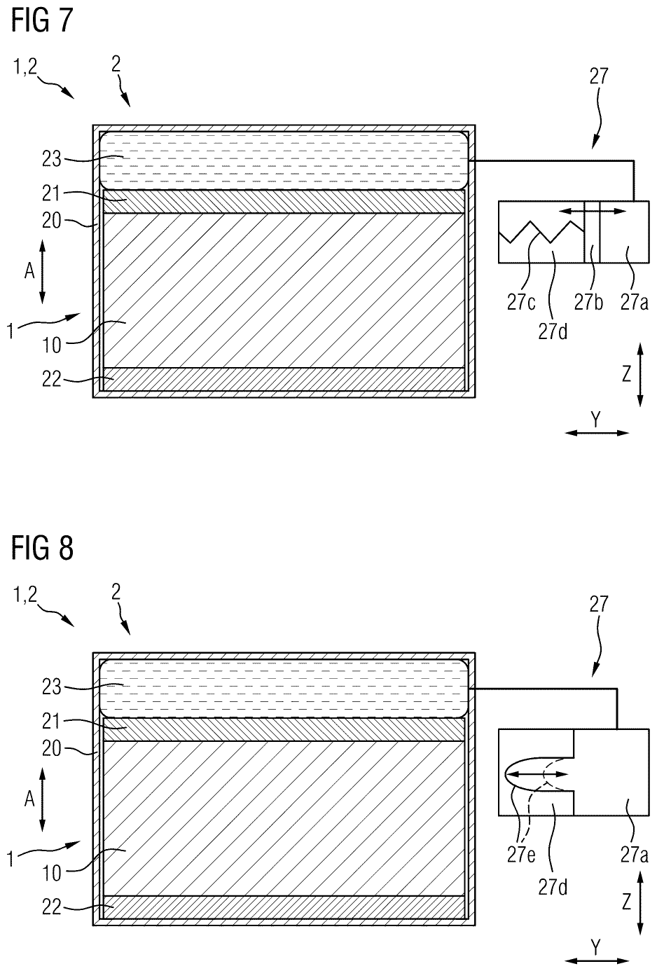

FIG. 7 shows a schematic representation of a solid-state accumulator system 1, 2 according to the invention having a solid-state accumulator holder 2 according to the invention according to a seventh exemplary embodiment. In this case, instead of an elastic equalizing volume 26 as in the sixth exemplary embodiment of FIG. 6, a rigid equalizing volume 27 is used, which is connected in a fluid-conducting manner to the variable fluid volume 23. To this end, the rigid equalizing volume 27 comprises a cylindrical housing (not designated), which together with a linearly movable piston 27b (see arrow) forms an equalizing chamber 27a, which is connected in a fluid-conducting manner to the variable fluid volume 23.

As the accumulator cell 10 expands, the movable piston 27b can be pushed by the hydraulic liquid against the force of a preload spring 27c in the form of a plate spring 27c, which is arranged on the opposite side of the movable piston 27b within a spring chamber 27d. If the accumulator cell 10 contracts again, then the hydraulic liquid is pushed by the preload spring 27c by means of the movable piston 27b out of the equalizing chamber 27a of the rigid equalizing volume 27 again and back into the variable fluid volume 23. In this manner too, the invention as described above can be implemented by means of a hydraulic liquid as the fluid.

FIG. 8 shows a schematic representation of a solid-state accumulator system 1, 2 according to the invention having a solid-state accumulator holder 2 according to the invention according to an eighth exemplary embodiment. In this case, instead of the movable piston 27b having a preload spring 27c, there is used an elastic membrane 27e in the form of an integrated elastomeric pressure regulating membrane 27e, comparable to the sixth exemplary embodiment of FIG. 6 of the elastic equalizing volume 26 or the elastomer bladder 26a thereof.

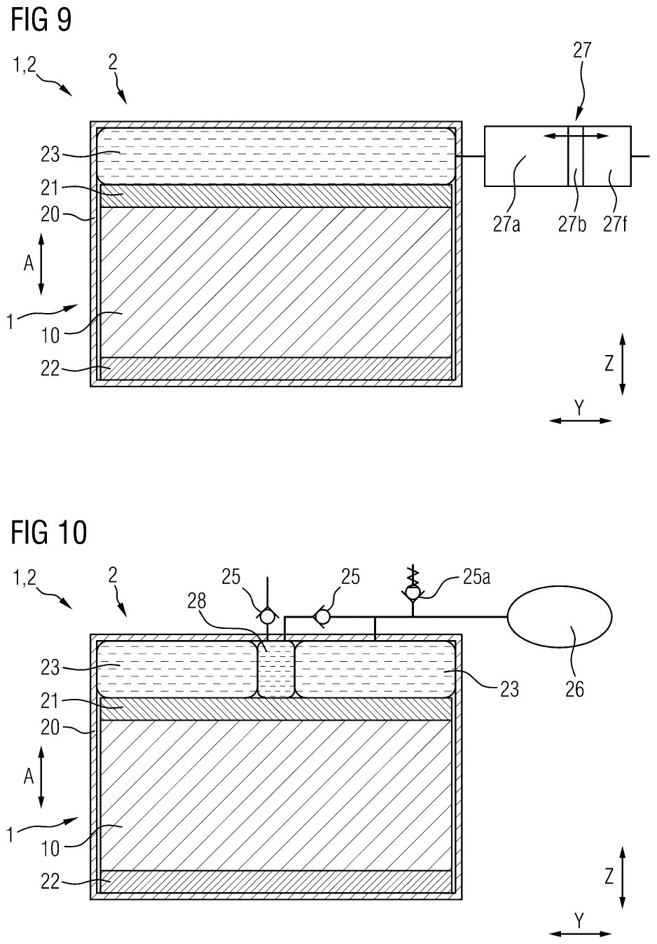

FIG. 9 shows a schematic representation of a solid-state accumulator system 1, 2 according to the invention having a solid-state accumulator holder 2 according to the invention according to a ninth embodiment. In this case, the movable piston 27b is arranged between the equalizing chamber 27a and a pressure equalizing chamber 27f, which in turn is connected in a fluid-conducting manner to a rigid or elastic equalizing volume. This can constitute an alternative possibility for implementation.

FIG. 10 shows a schematic representation of a solid-state accumulator system 1, 2 according to the invention having a solid-state accumulator holder 2 according to the invention according to a tenth embodiment. The variable fluid volume 23 surrounds in an annular manner a supplementary volume 28 in the form of a supplementary cushion 28. In the supplementary cushion 28 there is a defined quantity of air as the fluid. The supplementary cushion 28 is compressed by the expansion of the accumulator cell 10. As a result, the pressure in the air cushion 28 rises. If the pressure in the air cushion 28 is higher than the pressure in the variable fluid volume 23, or in the equalizing volume 26, then the check valve 25 that is arranged between the two air volumes of the variable fluid volume 23 and the supplementary cushion 28 opens. A pressure equalization takes place.

If, after this pressure equalization, the overall pressure of the system exceeds or approaches a critical value, then a spring-loaded check valve 25a opens. The excess air is discharged and the pressure in the system falls into the permissible range. Small air losses in the system can thus be compensated for.

If the accumulator cell 10 contracts, then air from outside at the instantaneously acting air pressure, or ambient pressure, enters the supplementary cushion 28 through the check valve 25 arranged between the supplementary cushion 28 and the environment. To this end, the air cushion 28 is fixedly connected to the first, upper holding element 21. The effect is comparable to an air pump which inflates a tire (each discharge/charge corresponds to a press of the pump).

### LIST OF REFERENCE SIGNS (PART OF THE DESCRIPTION)

A preferential dimensional-change direction; expansion/contraction direction
Y transverse direction; width
Z vertical direction; height
1,2 solid-state accumulator system
1 solid-state accumulator
10 accumulator cells
2 solid-state accumulator holder
20 frame; holder; housing
21 first, upper holding elements; first, upper holding plates; first, upper end plate
22 second, lower holding elements; second, lower holding plates; second, lower end plate
23 variable fluid volume; fluid cushion; air cushion
24 compressor
25 check valve; one-way valve; pressure relief valve
25a spring-loaded check valve
26 (elastic) equalizing volume
26a elastic outer shell; elastomer bladder
26b inner volume; elastic chamber
27 (rigid) equalizing volume
27a equalizing chamber
27b piston
27c preload spring; plate spring
27d spring chamber
27e elastic membrane; integrated elastomeric pressure regulating membrane
27f pressure equalizing chamber
28 variable supplementary volume; supplementary cushion

1. A solid-state accumulator system having at least one solid-state accumulator with a dimensional-change direction and
having at least one solid-state accumulator holder which is configured to counteract the dimensional change of the solid-state accumulator in the dimensional-change direction by at least one variable fluid volume.

2. The solid-state accumulator system as claimed in claim 1,
wherein the variable fluid volume is formed by a gas,

3. The solid-state accumulator system as claimed in claim 2,
wherein the solid-state accumulator holder comprises at least one compressor which is configured and adapted to generate a predetermined pressure of the gas.

4. The solid-state accumulator system as claimed in claim 2,
wherein the solid-state accumulator holder comprises at least one check valve, which is configured and adapted to open at a predetermined pressure of the variable fluid volume.

5. The solid-state accumulator system as claimed in claim 1,
wherein the variable fluid volume is formed by a hydraulic liquid, wherein the solid-state accumulator holder comprises at least one variable equalizing volume which is connected in a fluid-conducting manner to the variable fluid volume and is configured to exert a force on the liquid.

6. The solid-state accumulator system as claimed in claim 5,
wherein the variable equalizing volume is configured as an elastic equalizing volume having an elastic outer shell which holds the liquid in an inner volume

7. The solid-state accumulator system as claimed in claim 6,
wherein the elastic outer shell comprises, preferably consists of, an elastomeric material, which is fiber-reinforced and provided with tension cords.

8. The solid-state accumulator system as claimed in claim 5,
wherein the variable equalizing volume is configured as a rigid equalizing volume having an equalizing chamber the volume of which is variable by a movable spring-loaded or pressure-loaded piston.

9. The solid-state accumulator system as claimed in one of claim 1,
wherein the variable fluid volume is configured to exert a preload on the solid-state accumulator

10. The solid-state accumulator system as claimed in one of claim 1,
wherein the solid-state accumulator holder comprises at least one fluid inlet, which is configured and adapted to allow the quantity of fluid of the variable fluid volume to be introduced.

11. The solid-state accumulator system as claimed in one of claim 1,
wherein the solid-state accumulator holder comprises at least one pressure sensor, which is configured and adapted to detect a pressure of the fluid within the variable fluid volume

12. The solid-state accumulator system as claimed in one of claim 1,
wherein the variable fluid volume comprises, an elastomeric material, which is fiber-reinforced and provided with tension cords.

13. The solid-state accumulator system as claimed in claim 1,
wherein the solid-state accumulator comprises a plurality of accumulator cells which are arranged in the dimensional-change direction and/or perpendicular to the preferential dimensional-change direction,
wherein the solid-state accumulator holder is configured to counteract the dimensional change of all the accumulator cells in the dimensional-change direction by at least the variable fluid volume

14. The solid-state accumulator system as claimed in claim 1,
wherein the solid-state accumulator holder comprises a plurality of variable fluid volumes which are configured and arranged to counteract the dimensional change of one accumulator cell of the solid-state accumulator in the dimensional-change direction on one side or on both sides.

15. The solid-state accumulator system as claimed in claim 1,
wherein the solid-state accumulator holder comprises at least one variable supplementary volume which is arranged parallel to the variable fluid volume,
wherein the variable supplementary volume is connected by a first check valve to an ambient fluid, preferably to the ambient air, in order to receive ambient fluid when the pressure is falling, and
wherein the variable supplementary volume is connected by a second check valve to the variable fluid volume in order to discharge fluid to the variable fluid volume when the pressure is rising, so that a constant pressure can be maintained in the variable supplementary volume

16. A solid-state accumulator holder for use in a solid-state accumulator system as claimed in claim 1.

17. A solid-state accumulator system comprising:
a solid-state accumulator with a dimensional-change direction;
a solid-state accumulator holder configured to counteract a dimensional change of the solid-state accumulator in the dimensional-change direction by a fluid volume;
a compressor of the solid-state accumulator holder, the compressor to generate a predetermined pressure of the fluid volume;
a check valve to open at a second pressure of the fluid volume;
a hydraulic liquid as the fluid volume;
a variable equalizing volume to exert a force on the fluid volume, the variable equalizing volume configured as an elastic equalizing volume having an elastic outer shell; and
an elastomeric material reinforced with fiber and tension cords as the outer shell.
